(19) United States
(12) Patent Application Publication
(10) Pub. No.: US 2005/0242131 A1
(43) Pub. Date: Nov. 3, 2005

(54) Pull tab oil container opener

(76) Inventor: Kenneth Denning, Holland, MA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/057,401

(22) Filed: Feb. 11, 2005

Related U.S. Application Data
(60) Provisional application No. 60/567,180, filed on Apr. 29, 2004.

(51) Int. Cl. B67D 3/00

(52) U.S. Cl. 222/543

(57) ABSTRACT

A mechanism for opening a vehicle fluid container which is to be inserted into an engine to prevent spillage comprising: a seal affixed to the opening of the container preventing leakage; a pull chord affixed to the end extending down the side of the container; and pull tab means affixed to the chord for pulling on the chord.

This application claims priority to U.S. Provisional Patent Application No. 60/567,180 filed on Apr. 29, 2004, which is incorporated by reference herein, in its entirety.

### FIELD OF THE INVENTION

The invention is directed to a device used for opening a motor oil can, bottle or container and permitting the contents to be poured into a vehicle. In particular, the present invention is directed to a system where an oil receptacle is opened via its bottom so as to eliminate and minimize the spillage of oil or similar vehicle fluid down the inside of a vehicle.

### BACKGROUND OF THE INVENTION

Each year, car repair shops, so-called “quick oil and lube centers” and individual consumers use millions of quarts of motor oil and related fuel and oil additives. Motor oil and oil additives create a huge mess and can create a serious environmental problem. Motor oil is typically poured upside down into an engine part. Often the part is difficult to reach. Typically, oil has been distributed out of plastic or sealed containers into a funnel. This produces a fair amount of mess and spillage. More recently, there have been containers with long spouts or specialized nozzles. Such containers are more expensive to produce and use more plastics which present greater waste disposal and recycling problems.

The patent literature contains a number of patents directed to containers for storing and pouring motor oils and the like. U.S. Pat. No. 4,872,571, for example, discloses a container having an externally threaded pour spout on which an internally threaded cap is screwed. A tamper-proof, removable, membrane-like or diaphragm-like closure for the spout is secured to the circumferential lip of the spout with a peelable seal. The membrane-like closure has an elongated pull tab extending therefrom, by pulling on which the closure may be peeled off the end of the spout. The external threads on the spout are interrupted so as to provide a groove in which the pull tab resides out of engagement or interference with the external and internal threads on the spout and cap.

U.S. Pat. No. 5,915,578 discloses a pull-top closure for a container and a method of using the container incorporating the closure. The container is of the type commonly used for motor oil. It includes a main body having a top wall, a spout projecting upwardly from the top wall adjacent to one side of the body and terminating in a mouth. The top wall slopes from the spout to an upper corner on the opposite side of the body from the spout. The closure includes a seal releasably sealed to the mouth of the spout, a stem connected to the seal on the opposite side thereof from the upper corner and doubled back over the seal so as to extend toward the upper corner, and a ring connected to the stem so that the ring can be extended over the top wall between the spout and the upper corner. With the seal on the mouth of the spout, the container can be grasped around the upper corner between the thumb and middle finger of one hand so that the forefinger can extend over the top wall and be inserted into the ring thereby to hook the ring, and then the container inverted. The spout can then be inserted into the filler opening of an engine or other receptacle and the seal pulled off with the forefinger hooking the ring. This entire procedure can be accomplished with one hand of the user.

U.S. Pat. No. 5,005,732 discloses a spout, adapted for attachment to an oil can or the like, that has a generally tubular configuration. A tubular sleeve permits partial or total occlusion of the flow of liquid by axially moving the sleeve portion. Thus the spout may be closed before turning the oil can over for pouring the oil into an engine, then releasing the flow of oil when the spout is safely engaged into the engine crankcase inlet. Six embodiments of the invention are disclosed.

U.S. Pat. No. D288,059 discloses an ornamental design for an oil can opener with integral funnel, as shown in the Figures in the patent. U.S. Pat. No. 3,966,077 shows a production oil can for use in machine shops having a weighted base, flared rim and height proportionate to the size of brush used to oil machinery. A tool attachment for a drill press having an operative nylon member for stretching and deforming the base of tin cans to provide cavity space for weights in said base.

U.S. Pat. No. 6,170,716 discloses an oil can structure comprises an upper cover, a lock head, a jetting seat, a body, a lower seat, a piston, a sliding barrel and a rotary seat. Thereby, the oil can is operated easily and conveniently with less power and labor hour. The body receiving high pressure air and oil has an outer thread and an inner thread at the upper and lower inner side thereof. The outer thread has a jetting seat with a tube. The jetting seat has a jetting hole for jetting oil and air. Moreover, a lock head is installed at an outer cover of the jetting seat; the locking head has an inner thread for being screwedly engaged with the outer thread at the upper side of the body.

U.S. Pat. No. D253,521 discloses an ornamental design for a combined opener and spout for an oil can, as shown and described in the patent. U.S. Pat. No. 2,116,918 shows a dispensing funnel for sealed containers. It is a liquid dispensing device or funnel adapted to receive a sealed liquid container and having a cutter associated therewith for cutting a hole in the container through which the liquid may flow, and one important feature of the present invention resides in a dispensing device or funnel provided with a cutter that is constructed and arranged to cut an oil discharge opening in a side wall of the container near an end thereof.

The prior art related to oil can and bottles is thus characterized by specialized spout arrangements and/or use of funnels.

It is an object of the present invention to provide a motor oil and similar engine liquid dispensing system which does not spill.

It is a further object of the invention to provide an oil dispensing system in which the dispenser can be opened from the rear or bottom of the inverted container, after it has been inserted.

It is a further object of the present invention to provide a dispensing mechanism which can be used on a wide variety of automotive liquid products including motor oil, transmission fluid, oil additives or any other medium where a receptacle must be inverted to be emptied into a motor vehicle and the like and which use creates a risk of spillage or mess.

These and other objects of the present invention will become apparent from the summary and detailed description which follows.

### SUMMARY OF THE INVENTION

The novel oil container and opener of the present invention has a pull-tab ring at its end. It is shaped so that the end of the container that opens is able to pour easily into the correct place in a vehicle engine. The user of the container is able to pull the ring at the top or near the top of the container, which then pulls a I seal over the orifice, thus opening the orifice of the container and permitting the fluid to exit downwardly straight into the engine.

In a preferred embodiment, the present invention is a mechanism for opening a vehicle fluid container which is to be inserted into an engine to prevent spillage comprising: a seal affixed to the opening of the container preventing leakage; a pull chord affixed to the end extending down the side of the container; and pull tab means affixed to the chord for pulling on the chord and opening the container

In a further embodiment, the invention is a mechanism for opening a vehicle fluid container which is to be inserted into an engine to prevent spillage comprising: a seal with a tab affixed to the opening of the container preventing leakage; a pull chord affixed to the tab end extending down the middle of the interior of container and out an aperture on the bottom of the container; and pull tab means affixed to the chord for pulling on the chord and opening the container automatically pours the oil into the car.

In a further embodiment, a method for opening an automotive fluid container so as to minimize spillage is disclosed. The method comprises the following steps: affixing a seal over the opening of a container containing a vehicle fluid; affixing a pull chord to the seal; extending the pull chord down the side of the container and affixing it to a pull tab; inverting the container into a fluid port; pulling the pull tab so as to pull the chord and to opening the seal such that the vehicle fluid can be inserted into the vehicle without spillage.

### BRIEF DESCRIPTION OF THE DRAWINGS

FIG. 1 is a perspective view of the present invention

FIG. 2 is an underside perspective view of the present invention.

FIG. 3 is alternative embodiment of the present invention.

FIG. 4 is an underside perspective view of the alternative embodiment.

### DETAILED DESCRIPTION OF THE PREFERRED EMBODIMENT

The present invention is described with reference to the enclosed Figures wherein the same numbers are utilized where applicable. The invention, in a most preferred embodiment, is directed to a mechanism for opening and pouring a container of motor oil, oil additive, transmission fluid, anti-freeze, etc. from the rear and after the container has been placed inverted into the vehicle so as to minimize the size of the container, so as to eliminate spillage and so as to eliminate the need for a funnel.

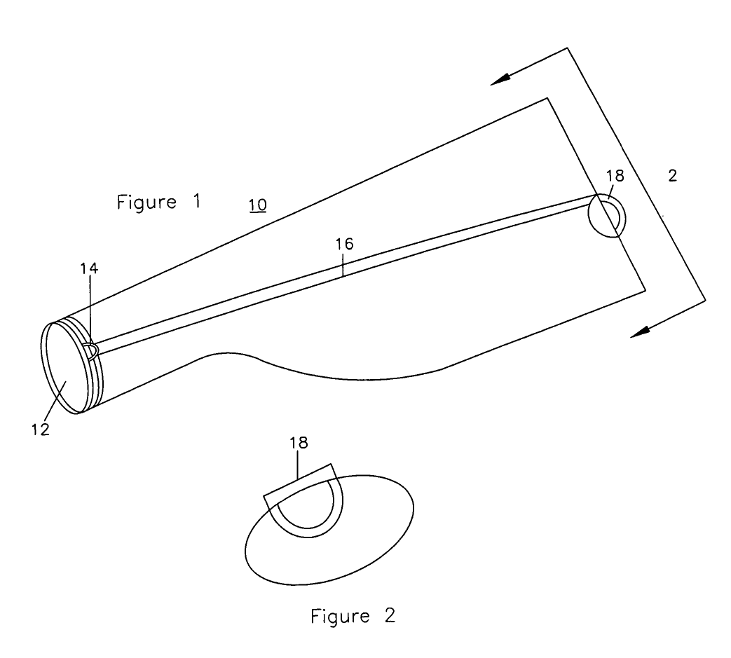

Referring to FIGS. 1 and 2, the present invention is shown as a polyurethane or plastic container 10 which includes an automotive fluid such as oil or an oil additive. The container has a spout which contains a sealing element 12. The sealing element, which in one embodiment comprises a circular polymeric seal 12 with a tab 14 which seals the flow of oil, etc. The seal 12 has a pull chord is 16 attached to the pull tab 14. The chord 16 extends down the side of the container and to the bottom (the top is then inverted in the engine). The end of the pull chord attaches to a pull tab 18. When the pull tab 14 is pulled upward, the chord is pulled 16 and the seal is torn open. Fluid can then flow into the appropriate fluid part of the engine.

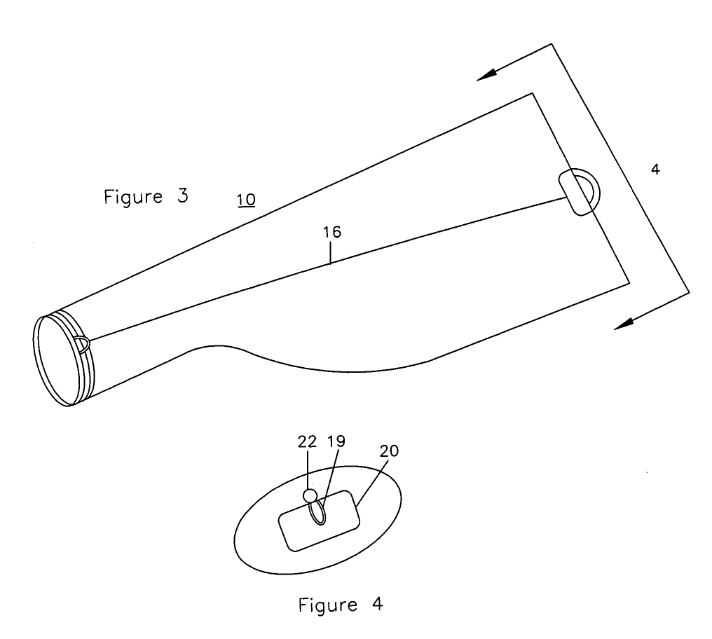

In an alternative embodiment of FIGS. 3 and 4, the pull chord 16 extends internally within the container 10 and exits near the center of the bottom 19 of the container. One end of the chord is attached internally to a pull tab 14. The bottom has a seal 20 and an associated pull ring 22 attached to the pull chord 16. When the seal 20 is removed, the pull ring 22 is pulled, thus applying tension on the chord 16 which pulls the seal 20 inward into the container 10 and thus opens the container. The oil or similar contents then pour downward, out of the container, into the engine. In both embodiments, the invention eliminates the need for a funnel or extended spout. The invention eliminates the mess and environmental hazard associated with motor oil and other vehicle fluids.

As noted, while the present invention has been described in the context of motor oil, it is to be appreciated that the teachings of the invention are applicable to a wide variety of engine and automotive fluids such as oil additives, transmission fluids, etc. The teachings are applicable to any liquid which needs to be emptied inverted and where preventing spillage is a factor. The true nature and scope of the invention is therefore to be determined with reference to the attached claims.

1. A mechanism for opening a vehicle fluid container which is to be inserted into an engine to prevent spillage comprising:
a seal affixed to the opening of the container preventing leakage;
a pull chord affixed to the seal at one end extending down the side of the container;
and pull tab means affixed to the second end for pulling on the chord and opening the container

2. The mechanism of claim 1 wherein the fluid is motor oil.

3. The mechanism of claim 1 wherein the fluid is an oil additive.

4. A mechanism for opening a vehicle fluid container which is to be inserted into an engine to prevent spillage comprising:
a seal with a tab affixed to the opening of the container preventing leakage;
a pull chord affixed to the tab end extending down the interior of the container and out an aperture on the bottom of the container; and
pull tab means affixed to the chord for pulling on the chord and opening the container

5. A method for opening an automotive fluid container so as to minimize spillage comprising the following steps:
affixing a seal to a container containing vehicle fluid;
affixing a first end of a pull chord to the seal;
extending the second end of the pull chord down the side of the container and affixing it to a pull tab;
inverting the container into a fluid port;
pulling the pull tab so as the chord is pulled and the seal is opened thus permitting the vehicle fluid to pour into the vehicle.

6. The method of claim 5 wherein the vehicle fluid comprises motor oil.

7. The method of claim 5 wherein the vehicle fluid comprises an oil additive.
